(19) United States
(12) Patent Application Publication
(10) Pub. No.: US 2023/0267678 A1
(43) Pub. Date: Aug. 24, 2023

(54) DEVICE AND METHOD FOR IMAGE PROCESSING

(71) Applicant: HUAWEI TECHNOLOGIES CO., LTD., Shenzhen (CN)

(72) Inventors: Pedro Vieira de CASTRO, London (GB); Manolis VASILEIADIS, London (GB); Ales LEONARDIS, London (GB); Benjamin BUSAM, London (GB)

(73) Assignee: HUAWEI TECHNOLOGIES CO., LTD., Shenzhen (CN)

(21) Appl. No.: 18/311,053

(22) Filed: May 2, 2023

Related U.S. Application Data
(63) Continuation of application No. PCT/EP2020/081391, filed on Nov. 6, 2020.

(51) Int. Cl. G06T 15/50; G06T 1/20; G06T 7/50

(52) U.S. Cl. CPC G06T 15/506; G06T 1/20; G06T 7/50; G06T 2207/10024; G06T 2207/10028; G06T 2207/20084

(57) ABSTRACT

A device comprising an image processor apparatus, the image processor apparatus being configured for implementing an image based computational model as part of an end-to-end processing pipeline. The device is configured to operate by receiving colour-specific image data representing a scene, receiving depth data of the scene, processing the colour-specific image data using the image based computational model to form a feature map of the scene, and forming in dependence on the feature map and the depth data an illumination map representing an estimation of the illumination on a set of three-dimensional locations in the scene.

### CROSS-REFERENCE TO RELATED APPLICATIONS

This disclosure is a continuation of International Application No. PCT/EP2020/081391, filed on Nov. 6, 2020. The disclosures of the aforementioned application are hereby incorporated by reference in entirety.

### FIELD OF THE INVENTION

This invention relates to estimation of illumination in scenes for object rendering.

### BACKGROUND

Augmented Reality (AR) applications are more popular than ever and users demand more realistic augmentations every day. Harmonization is the task of matching the appearance of two images by combining a foreground image extracted from one image with the background of another image, resulting in a realistic final composite. This is a key concept in AR, which allows an application the addition of an element to a scene without breaking the illusion. A key section of this task requires retrieving the illumination information from the background and applying it seamlessly on the foreground.

To successfully adjust these appearances, one faces three main challenges. Appearance harmonization, which concerns matching global image features, such as brightness, saturation, etc. Geometric harmonization, which concerns ensuring foreground positioning is geometrically consistent with the background. And lighting harmonization, which concerns recovering illumination information and correctly relighting the foreground.

Estimating illumination is an ill-posed problem since it requires inverting the effects of light sources, geometry reflections and occlusions, camera properties. Due to the 3D nature of a scene, the task of estimating light at a specific point in space is inherently 3D varying where the illumination changes with respect to the 3D position of the point.

There are several existing methods for retrieving global illumination or camera centered directional lighting. However, these methods are not sufficient for augmented reality applications. Some more recent spatially varying methods can retrieve direction illumination through dense or sparse methods. However, none of these are able to freely move added objects in 3D despite illumination not being a 2D task.

Retrieving illumination in the real world is very expensive, often requiring extensive scene preparation or large rigs. Existing methods have used adversarial examples in order to bridge the synthetic to real gap. Illumination is usually recovered using illumination retrieval techniques and provided in a representation that can be quickly emulated by an existing commercial renderer, including 2D spatially varying estimations.

An existing method has been proposed which extracts illumination from a smartphone front camera for screen brightness purposes. However, the lighting information retrieved from this method pertains to scene brightness only, with no measurement of direction or colour. On the other hand, other methods require multi-view as an input. Ideas like these exiting methods retrieve a global representation of the illumination of the scene, centred on the camera's position. These methods mostly diverge in data used for optimizing the used CNN's and light information representation, for example, using environment maps vs light sources. These methods cannot extract illumination on other points in space, requiring the sensors used to be moved in space for a new estimation. Existing methods struggle to extract lighting information from an area light or soft surface reflections. Other existing methods retrieve an egocentric lighting estimation based on an input image panorama.

Some existing methods are able to provide 2D spatially varying illumination, requiring recovering lighting information present on the surface of visible geometry. This task is simplified by the fact that the colour information on that region of the image contains key indicators of light information, for example, a bright region most likely means a strong light focus. These methods are not only restricted to 2.5D varying light estimation, but also cannot predict light on a point in space where there isn't a surface nearby.

Other existing methods include recovering light source positions. Such methods are restricted with regard to the number of existing light sources which can be extracted and cannot recover strong reflections and area lights. Some existing methods require a known object to be inserted into the scene. Through the known object's reflections, it is possible to recover light information on that position. None of the existing work mentioned above handles full 3D scene sampling for illumination estimation.

It is desirable to develop a method for accurately estimating three-dimensional lighting conditions within a scene.

### SUMMARY OF THE INVENTION

According to one aspect there is provided a device comprising an image processor apparatus, the image processor apparatus being configured for implementing an image based computational model as part of an end-to-end processing pipeline, the processing pipeline being configured to operate by: receiving colour-specific image data representing a scene; receiving depth data of the scene; processing the colour-specific image data using the image based computational model to form a feature map of the scene; and forming in dependence on the feature map and the depth data an illumination map representing an estimation of the illumination on a set of three-dimensional locations in the scene. Such an arrangement enables the incorporation of depth information into an illumination estimation without the need for direct measurements throughout the three-dimensional space. In an embodiment, the image based computational model may be a neural network model.

In an embodiment, the colour-specific image data may be received from a camera of the device. The depth data may be received from a depth sensor of the device or received as an estimation based on the colour-specific image data. Such an arrangement allows for the three-dimensional illumination map to be utilised even if the device does not have depth measuring capabilities.

In an embodiment, determining an illumination at a selected location within the scene may comprise shifting a frame of reference of the illumination map to be centred on the selected location and combining the illumination points of the illumination map based on their spatial distribution around the selected location at the centre of the frame of reference. The ability to shift the frame of reference of the illumination map rather than recalculating for a different set of coordinates within the scene drastically reduced the computational overheads of the required processing. This is particularly the case if multiple selected locations need to be represented simultaneously as multiple selected locations can also be represented by implementing a shifting of the reference frame.

In an embodiment, the illumination map comprises a plurality of illumination points, each illumination point representing for a corresponding pixel of the colour-specific image one of (i) an illumination level and (ii) an illumination hue. The illumination map may also further comprise data representing a depth corresponding to each illumination point. In an embodiment, a feature vector representation of the illumination at the selected location is extracted from the illumination map by an extraction neural network model. These feature work individually or in combination to provide an efficient and low computational cost system for estimating illumination conditions within a real or virtual scene.

According to a second aspect there is provided a computer-implemented method for processing an image by means of an image processor apparatus configured for implementing an image based computational model as part of an end-to-end processing pipeline, the method comprising: receiving colour-specific image data representing a scene; receiving depth data of the scene; processing the colour-specific image data using the image based computational model to form a feature map of the scene; and forming in dependence on the feature map and the depth data an illumination map representing an estimation of the illumination on a set of three-dimensional locations in the scene. By combining depth and illumination data together it is possible to estimate the illumination at points which exist between surfaces of a three-dimensional scene.

In an embodiment, the method may also comprise determining an illumination at a selected location within the scene by: shifting a frame of reference of the illumination map to be centred on the selected location; and combining the illumination points of the illumination map based on their spatial distribution around the selected location at the centre of the frame of reference. The ability to shift the frame of reference of the illumination map rather than recalculating for a different set of coordinates within the scene drastically reduced the computational overheads of the required processing.

In an embodiment, the method may also comprise extracting a feature vector representation of the illumination at the selected location from the illumination map by an extraction neural network model. Additionally, the method may comprise processing the feature vector representation to generate a colour-specific spherical harmonic representation, a depth spherical harmonic representation, and an indication of geometry distance estimation of the illumination at the selected location. The indication of geometry distance estimation may comprise one or more spherical harmonic coefficients, and the spherical harmonic representations each comprise 36 coefficients representing a respective degree of approximation each multiplied by 3 colour channels.

In an embodiment, the method may comprise implementing a discriminator neural network to validate the output of the processing pipeline by: distinguishing the feature vectors corresponding to synthetic images from the feature vectors corresponding to real images to produce a gradient; processing the gradient by a gradient reversal layer; and using the processed gradient to optimize the image based computational model and extraction neural network model. The image based computational model may be a neural network. The method can therefore be optimized with minimal real world data recording necessary, while still producing an illumination map which accurately estimates illumination in three-dimensions.

### BRIEF DESCRIPTION OF THE FIGURES

The present invention will now be described by way of example with reference to the accompanying drawings. In the drawings:

FIG. 1 shows an overview of the first half of the proposed pipeline;

FIG. 2 shows an overview of the second half of the proposed pipeline;

FIG. 3 shows how lighting information may be gathered through rendering a cubemap around a selected location.

FIG. 4 shows an example scene with an artificial object positioned at a selected location within the scene.

FIG. 5 shows a series of artificial objects positioned at selected locations within a scene.

FIG. 6 shows an example device for implementing the proposed image processing pipeline.

### DETAILED DESCRIPTION OF THE INVENTION

The presently proposed method is an end-to-end 3D spatially varying lighting estimation pipeline which retrieves illumination at any 3D position in the scene. The pipeline uses, as input, a colour image and depth information, either received directly from a sensor or estimated from the image. The output is directly provided as a standard representation, which is natively supported by off-the-shelf renderers. The presently proposed method supports real world AR applications through adversarial learning optimization, removing the need to collect expensive real-world illumination data.

Specifically, the proposed method leverages an image and depth measurement in order to construct a 3D feature structure describing the spatially varying 3D lighting. This 3D feature structure, also called an illumination map, can be sampled at any position.

The proposed method is an end-to-end deep learning pipeline, including a differentiable projection operation which allows for leverage of a colour-specific input image (e.g. RGB, CMYK, etc.) along with a pixel-wise depth measurement. The proposed method can sample sample lighting information in any 3D position in the scene, thus providing complete 3D sampling over all visible points in the scene, not just visible surfaces.

The sampling method for extracting information from the 3D scene relies on positioning the feature structure, also called a pointcloud or illumination map, relative to the target point or selected location to be sampled. This requires no additional learnable parameters or overhead to the model, reducing memory requirements on memory limited handheld devices. It is possible to simultaneously sample multiple 3D locations by exploiting a shift of the pointcloud reference frame. That is, multiple selected locations can be represented simultaneously by implementing a shifting of the reference frame. This also enables the applications potential throughput to be improved.

The proposed method can be optimized with colour-specific image data and depth map adversary examples in order to support real-life applications. As a result, the proposed method is able to recover the egocentric direction of sources of illumination

The core of the proposed method entails allowing for light estimation through Spherical Harmonics coefficient prediction with 3D sampling control. Such a method does not require multi-view or panorama images. Further, the method does not require the presence of a known object whose reflections are used for illumination retrieval.

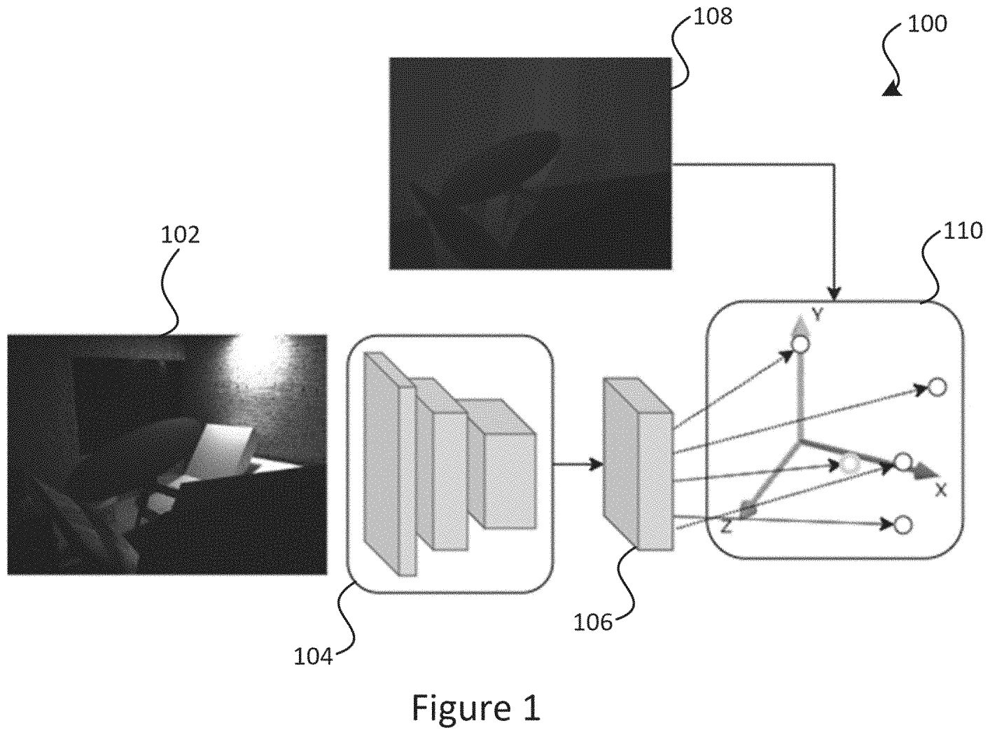

FIG. 1 shows an overview of the first half of the proposed pipeline 100. This half of the pipeline includes the generating of the illumination map 110. A colour-specific image 102 provides the raw illumination data to an image based computational model 104. The image based computational model 104 takes the colour-specific image data 102 and generates a feature map 106 of the scene in the image. The feature map 106 comprises an extraction of the illumination information contained within the colour-specific image data 102. The image based computational model 104 may be a neural network model. Depth data 108 is received by the pipeline, and this data may then be combined with the feature map 106 to form an illumination map 110. The illumination map 110 represents an estimation of the illumination on a set of three-dimensional locations in the scene. That is, the illumination map comprises information which enables the illumination qualities at locations within the three-dimensions of space within the scene to be estimated.

The colour-specific image data may be received from a camera of the device performing the scene rendering, or a camera connected thereto. The depth data may be received from a depth sensor of the device, or as an estimation based on the colour-specific image data.

The proposed 3D varying lighting estimation method first receives a 2D colour-specific image as an input, for example of size 640×480 pixels.

The proposed method starts by feeding this colour-specific image to a CNN in order to provide a feature map. In an example implementation the first four blocks of DenseNet, an existing neural network, has been used for this purpose. The image data is then encoded by this step, providing a 20×15×256 feature map. The specific size of the feature map can be subject to ablation study. The feature map 106 is optimized in order to describe scene lighting information.

Roughly midway through the pipeline, the proposed method uses a depth measurement 108 to improve illumination retrieval and allow for 3D spatially varying target sampling. The first two dimensions of the feature map, which represent the spatial structure of the input image, is then projected into 3D space, resulting in a pointcloud or illumination map. In the above example implementation this would result in an illumination map of size 300×(256+3), where 300 is the number of spatial positions which have been projected, and 256 are their correspondent features plus three egocentric spatial dimensions.

The resulting illumination map may comprise a plurality of illumination points, each illumination point representing for a corresponding pixel of the colour-specific image one of (i) an illumination level and (ii) an illumination hue. Once in three-dimensions the illumination map further comprises data representing a depth corresponding to each illumination point.

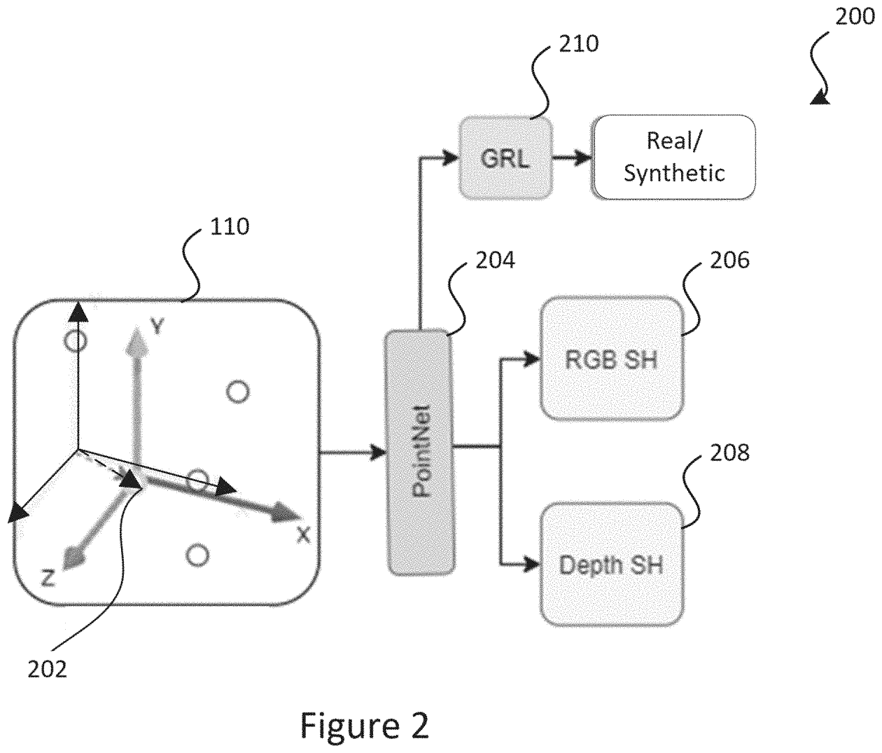

FIG. 2 shows an overview of the second half of the proposed pipeline 200. This part of the pipeline determines an illumination at a selected location 202 within the scene. This is achieved by re-centring the created illumination map around any target position by setting the origin of the illumination map 110 to that selected location 202, creating a shifted illumination map. It is then possible to use an extraction neural network 204, such as a PointNet network, to extract the illumination in an intermediate feature vector representation from the illumination map 110. That is, determining an illumination at a selected location within the scene comprises shifting a frame of reference of the illumination map to be centred on the selected location and combining the illumination points of the illumination map based on their spatial distribution around the selected location at the centre of the frame of reference. A feature vector representation of the illumination at the selected location may then be extracted from the illumination map by an extraction neural network model.

The generated feature vector can then be processed. Processing the feature vector representation generates a colour-specific spherical harmonic representation 206, a depth spherical harmonic representation 208, and an indication of geometry distance estimation of the illumination at the selected location. The proposed pipeline therefore outputs, as a result of this processing, the Spherical Harmonic (SH) representation of the scene's illumination at the selected location, along with an additional output pertaining to geometry distance estimation which is also in the form of one or more SH coefficients. The additional output pertaining to geometry distance estimation may assist in better occlusion estimation. Both of these SH representations 206, 208 may use 36×3 coefficients, where the 3 refers to the number of colour channels in the colour-specific image data and the 36 refers to the colour-specific image data's degree of approximation.

Additionally, the proposed method uses adversarial learning techniques to bridge the synthetic to real gap. In order to do so, a discriminator neural network is employed which is trained to distinguish intermediate feature vectors corresponding to synthetic or real images. The gradient produced by this network is then processed by a Gradient Reversal Layer, GRL, 210 before being used to optimize both the image based computational model when comprising a neural network and the extraction neural network. That is, implementing a discriminator neural network to validate the output of the processing pipeline comprises distinguishing the feature vectors corresponding to synthetic images from the feature vectors corresponding to real images to produce a gradient, processing the gradient by a gradient reversal layer, and using the processed gradient to optimize the image based computational model and extraction neural network model.

The proposed method generates synthetic data by incorporating a GPU based ray tracing engine and realistic indoor scenes. The indoor 2D renderings are generated from scenarios with randomized parameters. The randomized parameters may include multiple layouts which include bedrooms, living rooms, bathrooms and kitchens; walls and floors which are randomly textured and having randomized material properties; random placement of objects, e.g. taken from SceneNet, with appropriate texture and material properties also randomized; and different lighting placement, colour, and intensity.

For each of these renderings, the light information may be sampled at 4 positions in the observed space. The proposed method for generating the 2D dataset samples a point by passing a ray through each of the 4 quadrants of the rendering. While existing methods may then pick a position close to a surface, the herein proposed 3D dataset can randomly sample at any distance from the camera within the scene.

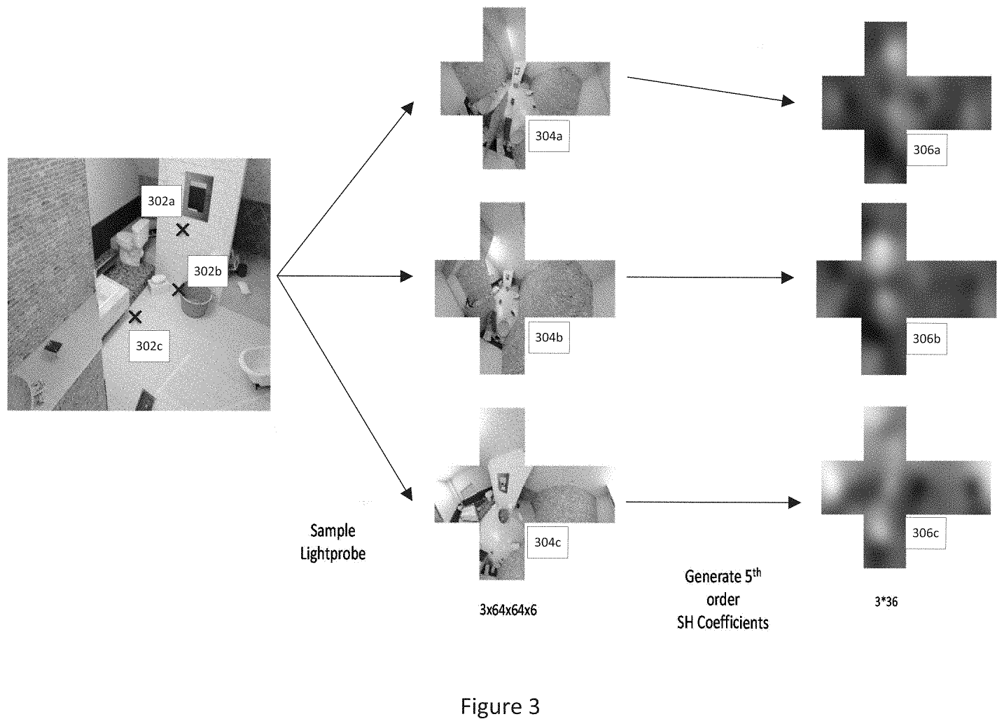

FIG. 3 shows how the lighting information may be gathered through rendering a cubemap around a selected location. The cubemap may then be used to generate the target SH coefficients. Specifically, FIG. 3 shows three different selected locations within the image data 302a-c. Each selected location 302a-c then has its own cubemap 304a-c rendered with the respective selected location 302a-c at the centre. FIG. 3 then shows the resulting SH representations 306a-c of each of these cubemaps 304a-c.

During training, the renderings may be augmented by performing different colour corrections, adding Gaussian and Salt&Pepper noise, and horizontal flipping. The cubemaps are modified accordingly.

The training data set created may comprise 16000 non-corrected images. Where 4 probes are collected for each image, providing 64k in total. The probe collection is from both on and off surfaces. This provides total 3D control. The training data comprises realistic room layouts with random surface texturing, e.g., 10 for each room, and random light sources, e.g. 10 for each room. There is also random furniture placement.

The loss function used to optimize the proposed pipeline is a combination of multiple losses, each of which will now be detailed below.

Firstly the proposed method is optimized to estimate lighting information in SH format. To achieve this, the L2 distance between the predicted and ground-truth 36×3 SH coefficients representing colored light “SH” is minimized according to:

$${L}_{SH} = \frac{1}{36} {\sum }_{i = 0}^{36} {‖ {SH}^{i} - {SH}^{ri} ‖}_{2}$$

where SH′ and SH are the predicted and groundtruth depth SH coefficients, respectively, and i refers to the SH order.

The distance between the depth SH coefficients “DSH” is also minimized according to:

$${L}_{DSH} = \frac{1}{36} {\sum }_{i = 0}^{36} {‖ {DSH}^{i} - {DSH}^{ri} ‖}_{2}$$

where DSH′ and DSH are the predicted and groundtruth depth SH coefficients respectively, and i refers to the SH order.

An adversarial task is employed, which is optimized through the GRL. The loss function used may for example be the simple binary cross entropy loss:

L_{Adverserial}=−log(c′)*c

where c′ and c are the predicted and groundtruth domain classification binary flags.

These losses may be combined with equal weighting.

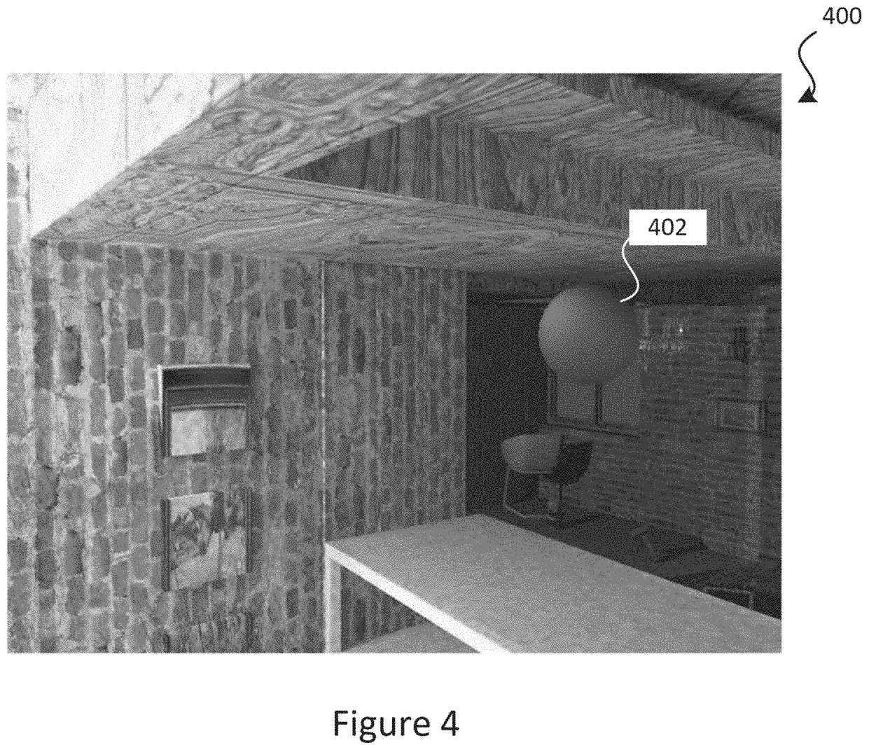

FIG. 4 shows an example scene 400 with an artificial object 402 positioned at a selected location within the scene. The object 402 is a sphere which has been rendered to appear to be illuminated in dependence on its location within the scene. It can be seen that object 402 is not significantly close to any particular surface and that its illumination is that of an object in free space located between the objects in the scene but not at a location where another object already exists. A lighter area exists on the left-hand face of the sphere, in keeping with the brighter light in the left-hand foreground of the scene, and the right-hand and top surfaces of the sphere have a more shading in keeping with the low ceiling and dark far corner of the scene.

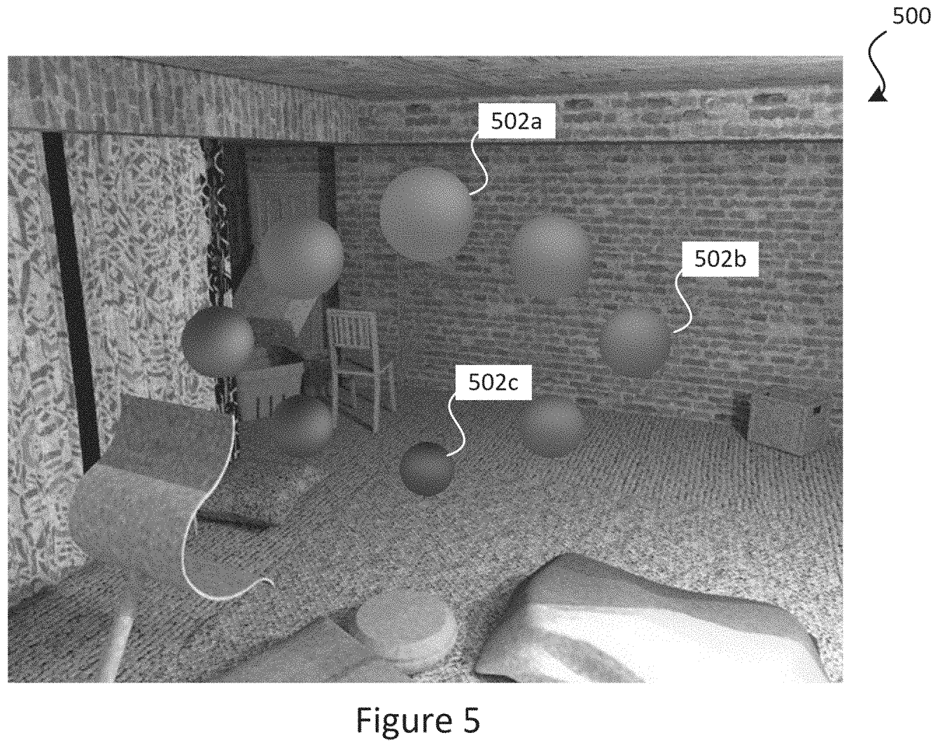

FIG. 5 shows a series of artificial objects 502a-c positioned at selected locations within the scene 500. The objects 502a-c are spheres, where the smaller spheres are further away from the viewer than the larger spheres. The spheres have been rendered to appear to be illuminated in dependence on their location within the scene. It can be seen that the objects 502a-c are not significantly close to any particular surface and that their illumination is that of an object in free space located between the objects in the scene but not at a location where another object already exists. Again, the close sphere 502a is more brightly lit, representing the lighting present in the front half of the room. The furthest sphere 502c is lit more in keeping with the back of the room, where there is little light. It can be seen that sphere 502c is not merely lit in dependence on the background directly behind it, it is recognized that the sphere is not at the same depth as the ground behind it and therefore sphere 502c has been rendered to have surface illumination in keeping with its 3D position within the scene.

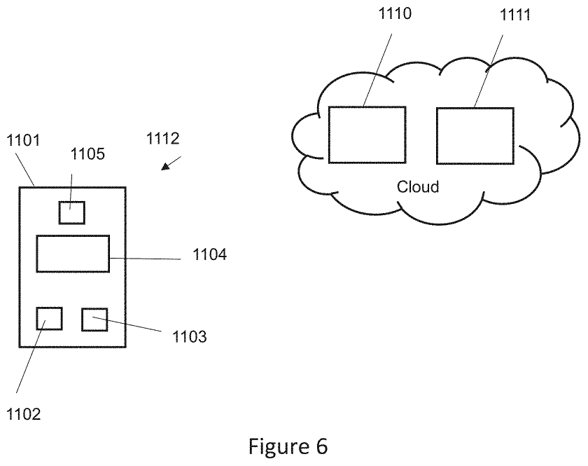

FIG. 6 shows an example of a camera configured to implement the image processor to process images taken by an image sensor 1102 in a camera 1101. Such a camera 1101 typically includes some onboard processing capability. This could be provided by the processor 1104. The processor 1104 could also be used for the essential functions of the device. The camera typically also comprises memory a 1103.

The transceiver 1105 is capable of communicating over a network with other entities 1110, 1111. Those entities may be physically remote from the camera 1101. The network may be a publicly accessible network such as the internet. The entities 1110, 1111 may be based in the cloud. In one example, entity 1110 is a computing entity and entity 1111 is a command and control entity. These entities are logical entities. In practice they may each be provided by one or more physical devices such as servers and datastores, and the functions of two or more of the entities may be provided by a single physical device. Each physical device implementing an entity comprises a processor and a memory. The devices may also comprise a transceiver for transmitting and receiving data to and from the transceiver 1105 of camera 1101. The memory stores in a non-transient way code that is executable by the processor to implement the respective entity in the manner described herein.

The command and control entity 1111 may train the neural network models used in the proposed method. This is typically a computationally intensive task, even though the resulting model may be efficiently described, so it may be efficient for the development of the algorithm to be performed in the cloud, where it can be anticipated that significant energy and computing resource is available. It can be anticipated that this is more efficient than forming such a model at a typical camera. However, situations are described above in the context of the presently proposed method which enable it to be implemented on devices with limited memory resources.

In one implementation, once the algorithms have been developed in the cloud, the command and control entity can automatically form a corresponding model and cause it to be transmitted to the relevant camera device. In this example, a pre-trained set of neural network models are implemented at the camera 1101 by processor 1104.

In another possible implementation, an image may be captured by the camera sensor 1102 and the image data may be sent by the transceiver 1105 to the cloud for processing in the system. The resulting target image could then be sent back to the camera 1101.

In yet another possible implementation, an image may be captured by the camera sensor 1102 and the image data and depth data may be processed directly by the image processor apparatus of the device without assistance by external systems.

Therefore, the method may be deployed in multiple ways, for example in the cloud, on the device, or alternatively in dedicated hardware. As indicated above, the cloud facility could perform training to develop new algorithms or refine existing ones. Depending on the compute capability near to the data corpus, the training could either be undertaken close to the source data, or could be undertaken in the cloud, e.g. using an inference engine. The system may also be implemented at the camera, in a dedicated piece of hardware, or in the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A device comprising an image processor apparatus, the image processor apparatus being configured for implementing an image based computational model as part of an end-to-end processing pipeline, the device is configured to perform:
receiving colour-specific image data representing a scene;
receiving depth data of the scene;
processing the colour-specific image data using the image based computational model to form a feature map of the scene; and
forming in dependence on the feature map and the depth data an illumination map representing an estimate of the illumination on a set of three-dimensional locations in the scene.

2. The device according to claim 1, wherein the image based computational model is a neural network model.

3. The device according to claim 1, wherein the colour-specific image data is received from a camera of the device.

4. The device according to claim 1, wherein the depth data is received from a depth sensor of the device.

5. The device according to claim 1, wherein the depth data is received as an estimate based on the colour-specific image data.

6. The device according to claim 1, wherein determining an illumination at a selected location within the scene comprises shifting a frame of reference of the illumination map to be centred on the selected location and combining the illumination points of the illumination map based on their spatial distribution around the selected location at the centre of the frame of reference.

7. The device according to claim 6, wherein multiple selected locations can be represented simultaneously by implementing a shifting of the reference frame.

8. The device according to claim 1, wherein the illumination map comprises a plurality of illumination points, each illumination point representing for a corresponding pixel of the colour-specific image one of (i) an illumination level or (ii) an illumination hue.

9. The device according to claim 8, wherein the illumination map further comprises data representing a depth corresponding to each illumination point.

10. The device according to claim 1, wherein a feature vector representation of the illumination at the selected location is extracted from the illumination map by an extraction neural network model.

11. A computer-implemented method for processing an image by means of an image processor apparatus configured for implementing an image based computational model as part of an end-to-end processing pipeline, the method comprising:
receiving colour-specific image data representing a scene;
receiving depth data of the scene;
processing the colour-specific image data using the image based computational model to form a feature map of the scene; and
forming in dependence on the feature map and the depth data an illumination map representing an estimate of the illumination on a set of three-dimensional locations in the scene.

12. The method according to claim 11, comprising determining an illumination at a selected location within the scene by:
shifting a frame of reference of the illumination map to be centred on the selected location; and
combining the illumination points of the illumination map based on their spatial distribution around the selected location at the centre of the frame of reference.

13. The method according to claim 12, comprising extracting a feature vector representation of the illumination at the selected location from the illumination map by an extraction neural network model.

14. The method according to claim 13, comprising processing the feature vector representation to generate a colour-specific spherical harmonic representation, a depth spherical harmonic representation, and an indication of a geometry distance estimate of the illumination at the selected location.

15. The method according to claim 14, wherein the indication of the geometry distance estimate comprises one or more spherical harmonic coefficients.

16. The method according to claim 14, wherein the spherical harmonic representations each comprise 36 coefficients representing a respective degree of approximation each multiplied by 3 colour channels.

17. The method according to claim 11, comprising implementing a discriminator neural network to validate the output of the processing pipeline by:
distinguishing the feature vectors corresponding to synthetic images from the feature vectors corresponding to real images to produce a gradient;
processing the gradient by a gradient reversal layer; and
using the processed gradient to optimize the image based computational model and extraction neural network model.

18. The method according to claim 11, wherein the image based computational model is a neural network.
